(19) United States
(12) Patent Application Publication
(10) Pub. No.: US 2026/0001671 A1
(43) Pub. Date: Jan. 1, 2026

(54) PACKAGING UNIT FOR PACKAGING ARTICLES INTO BOXES AND RELATIVE PACKAGING METHOD

(71) Applicant: R.A JONES & CO., Covington (KY)

(72) Inventors: Andrea BIONDI, BOLOGNA (IT); Luca CAVAZZA, BOLOGNA (IT); Enrico FEDERICI, BOLOGNA (IT); Enrico CAMPAGNOLI, BOLOGNA (IT); Gianluca PARISINI, BOLOGNA (IT)

(21) Appl. No.: 18/881,160

(22) PCT Filed: Jul. 13, 2023
(86) PCT No.: PCT/IB2023/057207

§ 371 Date: Jan. 3, 2025

(30) Foreign Application Priority Data
Jul. 22, 2022 (IT) 102022000015492

(51) Int. Cl. B65B 43/28; B65B 5/04; B65B 25/00; B65B 41/04; B65B 43/26

(52) U.S. Cl. CPC B65B 43/285; B65B 5/04; B65B 25/00; B65B 41/04; B65B 43/265

(57) ABSTRACT

A unit and a method of packaging items into boxes. The packaging unit includes: a gripping device for gripping a blank to be folded to form a box configured to contain at least one of the articles, the blank having a panel and an end flap extended from the panel, the gripping device being configured to define a gripping position for the panel; an abutment element to abut at least partially the panel and bearing a folding edge; a pressing element to press the panel against the abutment element in proximity of the folding edge; and a folding element to fold the end flap relative to the panel about the folding edge and in direction of the abutment element when the gripping device is in the gripping position for the panel and the panel is pressed at least partially by the pressing element against the abutment element.

The present invention refers to a unit and a method for packaging articles into boxes.

The present invention finds a preferred, though not exclusive, application in the field of packaging articles of variable geometry and which are relatively delicate in boxes, such as bags of cereals, a field to which reference will be made later without losing generality.

In particular, in the relevant technical field, packaging units are known in which the packaging of the article inside a box is obtained from a blank which is wrapped around the article.

This well-known packaging mode, also known as the “wrap-around” type mode, envisages the box being formed by wrapping the blank, e.g., a shaped cardstock, around a mandrel containing the article to be packaged. Such a mode envisages that the blank is wrapped around the mandrel so as to form a box closed laterally but open at least at one end thereof, from which the mandrel is then extracted, leaving the article inside the newly formed box. The open end can then be closed again, so that the resulting package can be sent to the final packaging steps.

In the present disclosure as well as in the accompanying claims, certain terms and expressions are deemed to assume, unless otherwise expressly indicated, the meaning expressed in the following definitions.

The term “article” means any product which can be packaged into boxes. The articles can have a predefined geometric shape or they can have a variable geometry.

Non-exclusive examples of such articles are known from the food and confectionery sector and can refer to loose articles or those contained inside bags, pouches or other types of wrapper.

Preferably, the articles are food and confectionery articles, either loose or contained inside bags or other types of wrapper, such as bags of cereals or capsules of coffee or other brewing beverages, individual chocolates (wrapped or unwrapped), candies, pouches containing solid, liquid or semi-solid food products; in addition, articles from the ceramic industry, absorbing articles for sanitary use, articles from the tobacco industry, articles from the cosmetics industry, articles from the pharmaceutical industry, articles from the personal & home care industry.

“Packaging” of one or more articles in a box means obtaining a box containing said one or more articles. Such packaging can be obtained by forming a box around the article to be contained.

“Mandrel” means a support capable, on the one hand, of accommodating and supporting the article to be packaged and, on the other hand, of providing an effective abutment for folding the blank when wrapped around the same.

“Blank” means a shaped sheet of suitable material and thickness adapted to be wrapped by folding around a mandrel to form a box. Panels are identified in the blank, delimited by preferred folding lines, which form the walls of the formed box. Preferably, the blank is made of cardboard or cardstock.

“Box” means any container adapted to contain one or more articles for the purpose of packaging them, which can be made from a blank by folding around a mandrel and subsequent fixing at its edges or panels.

A box is “partially closed” when it has at least one closed contour section, most preferably when it is closed laterally around the mandrel while the longitudinal ends are kept open.

A “flap” refers to a region of the blank that allows fixing the blank to another region in such a way as to form an at least partially closed box, preferably around a mandrel.

Some non-limiting examples of such a fixing are gluing, stapling and jointing by means of interlocking elements or elements with laces and hooks (Velcro®).

The term “end flap” refers to a flap that extends from one side or end zone of a panel of the blank.

In particular, the fixing to form an at least partially closed box takes place by at least partially overlapping two end flaps of the blank, an inner flap and an outer flap.

Specifically, “outer flap” intends to indicate the flap that, overlapped on the inner flap, is located outside the at least partially closed box, whereas “inner flap” intends to indicate the flap that, overlapped on the outer flap, is located between it and the inside of the at least partially closed box.

The “folding line” of a blank is defined as a predefined line around which two portions or panels of the blank are envisaged to rotate relative to each other so as to fold the blank.

The folding line can be a virtual, albeit predefined, line.

The folding line is preferably defined by a weakening line obtained on the blank, e.g., a crease, or a scoring or a plurality of aligned holes.

In general, a first element is configured to “abut” a second element when the first element is arranged to touch the second element by exerting pressure thereon.

The “folding edge” of an element means an end edge of said element around which the end flap is rotated relative to the portion or panel of the blank from which the flap extends.

The expression “in proximity of the folding edge” is intended to refer to a distance from the folding edge of less than a few millimetres. This distance can assume values between 1 and 10 mm, for example.

The “handling device” of a pressing or folding element can be understood as any device capable of moving the pressing or folding element along its respective handling trajectory. Examples of handling devices are electric, pneumatic or hydraulic actuator systems.

The term “vertical” means an orientation extended parallel to the direction of the force of gravity.

The term “horizontal” means an orientation extended substantially perpendicular to the vertical direction.

In “wrap-around” type packaging processes, it is provided that the article to be packaged is fed along a transport line to be transferred and accommodated inside a mandrel. Said mandrel is moved along a trajectory of movement of a forming path in which the step of wrapping the blank around the mandrel occurs with the formation and closure of the box, e.g., by gluing overlapped flaps thereof.

In the first box formation step, it is envisaged that the blanks are inserted one at a time in the forming path. This insertion operation is carried out so that a respective mandrel intercepts a corresponding blank along the movement trajectory in a position intersecting the trajectory.

Typically, the blank is brought to the insertion position in the handling trajectory by means of a gripping device, designed to grip the blank. For this purpose, the gripping device is equipped with gripping elements, e.g. made of vacuum suction cups.

At this stage of handling the gripping device, if gluing between the inner and outer flaps is envisaged, the adhesive is applied to the outer flap of the blank, e.g. in the form of a series of glue dots distributed on the surface of the outer flap.

In addition, it is also advisable to include a folding step, at least partial, of the inner flap, in order to induce an initial yielding of the fibres of the blank along the folding line of the inner flap, in order to subsequently facilitate the completion of the folding by the correct overlapping of the inner and outer flaps, when the blank is wrapped around the mandrel and the outer and inner flaps are overlapped one on top of the other and pressed against the mandrel to ensure their relative gluing.

The Applicant noted that this preliminary folding step of the inner flap is critical for the correct and precise closure of the blank, in the formation of a partially closed box, once the blank is wrapped around the mandrel.

In fact, the Applicant has observed that, in order to ensure the correct overlap between the outer and inner flaps, it is necessary that the inner flap assumes a position that is at least partially folded around the corresponding folding edge of the mandrel, when it is impacted by the outer flap. Otherwise, in fact, jams could occur between the flaps or even the case could occur in which the inner flap is not impacted by the outer flap. In all conditions, in which there is no correct condition of relative overlap, there is therefore a risk that the flaps are not correctly glued together, compromising the closure of the box.

The Applicant has therefore found that a preliminary folding step aimed at introducing at least partial folding of the inner flap, for example by inducing yielding around its folding line, carried out prior to wrapping the blank around the mandrel, can be effective and the effectiveness is all the greater the more the inner flap is able to assume and maintain a fold suitable to allow the correct impact of the outer flap. In fact, the yielding of the inner flap is in any case subject to a partial release due to the elastic return, the extent of which may vary depending on the dimensions and thickness of the blank as well as on the nature of the material with which it is made.

The Applicant has therefore understood that, in order to ensure that the inner flap assumes and maintains an adequate folding angle, up to the gluing step with the outer flap, ensuring a correct condition of relative overlap, it is appropriate that the inner flap is subjected to folding while the rest of the blank, and in particular the region of the blank extending close to the inner flap, should be abutted and retained in an undeformed condition, so that the region of the blank immediately adjacent to the inner flap cannot follow the folding movement of the inner flap, thus limiting the yielding along the folding line, with a consequent reduction in the folding angle.

The Applicant finally found that performing the folding of the inner flap while the region of the blank extending close to the inner flap is pressed against an abutment element in proximity of a flap folding edge, could ensure that a suitable inner flap fold was achieved and maintained to facilitate the subsequent precise positioning with the outer flap, in order to achieve a correct relative overlap condition, when closing the box.

Therefore, in a first aspect thereof, the present invention is directed to a unit for packaging articles into boxes comprising a unit for packaging articles into boxes.

Preferably, the packaging unit comprises a gripping device of at least one blank intended to be folded to form a box adapted to contain at least one of said articles.

Preferably said at least one blank has at least one panel and at least one end flap extending from said at least one panel.

Preferably the gripping device is configured to define a gripping position for said at least one panel,

Preferably, the packaging unit comprises an abutment element configured to abut at least partially said at least one panel.

Preferably the abutment element has a folding edge.

Preferably the packaging unit comprises a pressing element.

Preferably the pressing element is configured to press said at least one panel against said abutment element in proximity of said folding edge.

Preferably the packaging unit comprises a folding element.

Preferably the folding element is configured to fold said at least one end flap relative to said at least one panel about said folding edge and in the direction of said abutment element.

Preferably the folding element is configured to fold said at least one end flap when said gripping device is in the gripping position for said at least one panel and said at least one panel is pressed at least partially by said pressing element against said abutment element.

In a second aspect thereof, the present invention is directed to a method for packaging articles into boxes.

Preferably, this method comprises the step of preparing a blank intended to be folded to form a box adapted to contain at least one of said articles.

Preferably said at least one blank is arranged to have at least one panel and at least one end flap extending from said at least one panel.

Preferably, the method comprises the step of abutting the at least one panel by means of an abutment element.

Preferably the abutment element is designed to bear a folding edge.

Preferably, the method comprises the step of pressing the at least one panel against said abutment element in proximity of said folding edge.

Preferably the method comprises the step of folding said at least one end flap relative to said at least one panel around the folding edge and in the direction of the abutment element, when said at least one panel is pressed against said abutment element.

Thanks to these characteristics, the folding of the end flap, also known as the inner flap, takes place in a precise manner, ensuring that a suitable folding angle is maintained to ensure that the outer flap can properly impact the inner flap when the box is closed, so that these flaps are in the correct relative overlap condition for gluing them together.

In at least one of the aforementioned aspects, the present invention may further have at least one of the preferred features set forth below.

In a preferred embodiment, said pressing element is movable with respect to the gripping device.

Preferably, the packaging unit comprises respective and separate handling devices for said pressing element and said folding element.

Thanks to this feature, the control of the separate movements of the pressing element and the folding element is simple and effective to implement.

Preferably, the pressing element handling device and the folding element handling device are movably guided along a common handling trajectory.

Preferably this handling trajectory is rectilinear.

In a preferred embodiment, said folding element is articulated to said pressing element to rotate about a first axis of rotation.

This ensures precise relative positioning between the pressing and folding elements, suitable for correctly impacting the panel and the end flap respectively.

Preferably said pressing element is rigidly fixed on its respective handling device and the folding element is supported in an articulated manner on its respective handling device about a second axis of rotation.

Thanks to this feature, the conversion of a relative translation movement between the respective control devices of the pressing and folding elements into a rotation movement of the folding element relative to the pressing element is achieved in a simplified manner.

Preferably the first and second axis of rotation are parallel and spaced apart from one another.

Preferably said first and second axis of rotation are directed transverse to the handling trajectory.

In a preferred embodiment, said handling devices are configured to be driven synchronously along at least a first section of the handling trajectory, so that the pressing element and the folding element are driven without any relative movement between each other.

Preferably, the handling device of the folding element is configured to be driven, along a second section of the handling trajectory, in a relative movement with respect to the handling device of the pressing element, so that the folding element is moved in a relative rotation movement with respect to the pressing element.

In this way, the actions of pressing the panel against the abutment element and folding the end flap around the folding edge can be exerted separately, making the command and control of the movements of said elements simple, yet reliable, to implement.

Preferably said first and second trajectory sections follow one another defining a handling stroke towards said abutment element, at the end of the first trajectory section the pressing element being moved to an operating position wherein it presses said at least one panel of the blank against the abutment element and in the second trajectory section the folding element being moved to fold the at least one end flap about the folding edge while the pressing element is maintained in said operating position.

In a preferred embodiment, the pressing element comprises a main stop body intended to press with contact said at least one blank and mounted on respective supports, said main stop body being fixed to said supports by interposing a spring system.

Thanks to this feature, uniform contact of the pressing element on the panel surface pressed against the abutment element is guaranteed, the spring system also compensating for any relative alignment errors between the pressing element and the abutment element.

Preferably, the handling device of the pressing element and the handling device of the folding element are movably guided on a frame structurally independent from said gripping device.

Preferably, the pressing element is mounted on the gripping device of said at least one blank.

Preferably the pressing element and the folding element are configured to respectively press the blank against the abutment element and fold the end flap, when the blank is stopped in a stop position at the abutment element.

This ensures precision in the relative positioning between the blank and the pressing and folding elements, and simplifies the required movements of the pressing and folding elements relative to the blank.

In a preferred embodiment, the packaging unit comprises a plurality of said gripping devices mounted on a rotatable carousel, which are configured in such a way that in a rotary movement of said carousel, the gripping devices are driven, in succession to each other, towards said abutment element to fold the end flap of the blank gripped on the corresponding gripping device.

In a preferred embodiment, the packaging method comprises the steps of arranging a pressing element to press the at least one panel, arranging a folding element to fold the end flap, and moving said pressing element and said folding element to and from said abutment element along a common trajectory.

Preferably in such a handling step, the pressing element and the folding element are driven synchronously along a first section of said trajectory, without reciprocal relative movement, and are driven along a second section of said trajectory with a relative movement to fold the end flap in the direction of the abutment element.

In a preferred embodiment, the packaging method comprises the steps of moving the at least one panel in the direction of the abutment element, and stopping the panel at the abutment element so that the end flap is folded when the at least one panel is in a stopped position with respect to the abutment element.

Preferably, the packaging method comprises the steps of grasping the at least one blank, by means of a gripping device, and moving the gripping device to move the at least one gripped blank to and from said abutment element.

In a preferred embodiment, the method comprises the steps of arranging a plurality of gripping devices on a rotatably driven carousel, and moving said gripping devices, in succession to each other, towards said abutment element, to fold the end flap of each blank gripped on the corresponding gripping device around the folding edge.

It should be specified that some steps of the method described above may be independent of the order of execution reported. In addition, some steps may be optional. In addition, some steps of the method may be performed repetitively, or may be performed in series or in parallel with other steps of the method.

The characteristics and advantages of the present solution will best result from the detailed description of some preferred embodiments thereof, illustrated by way of non-limiting example with reference to the accompanying drawings, in which:

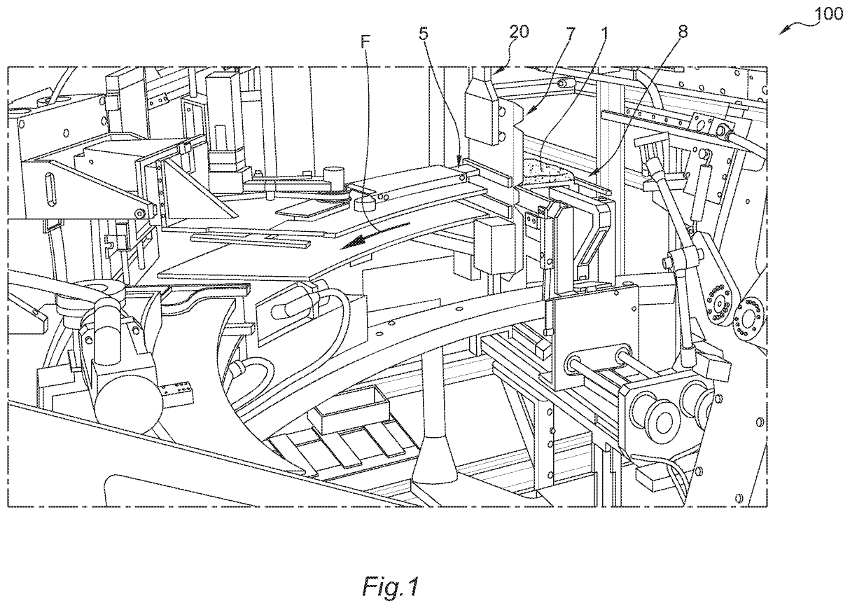

FIG. 1 is a schematic partial perspective view of a unit for packaging articles into boxes realised in accordance with the present invention,

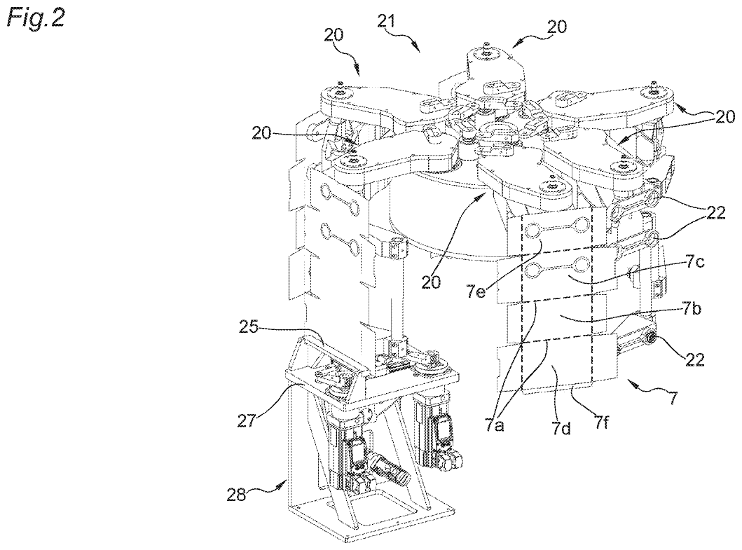

FIG. 2 is a perspective view of a detail of the packaging unit of FIG. 1,

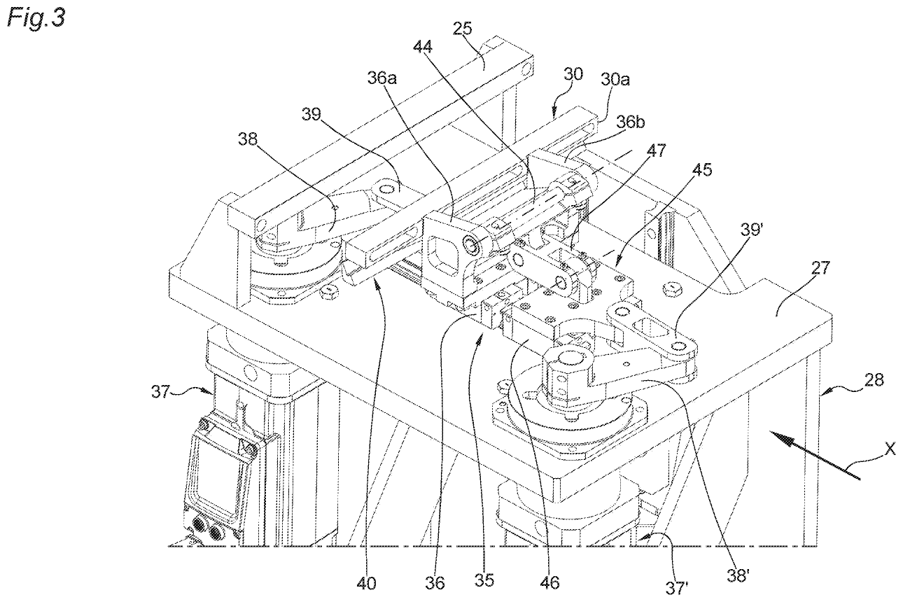

FIG. 3 is a partial perspective and enlarged scale view of a detail of FIG. 2,

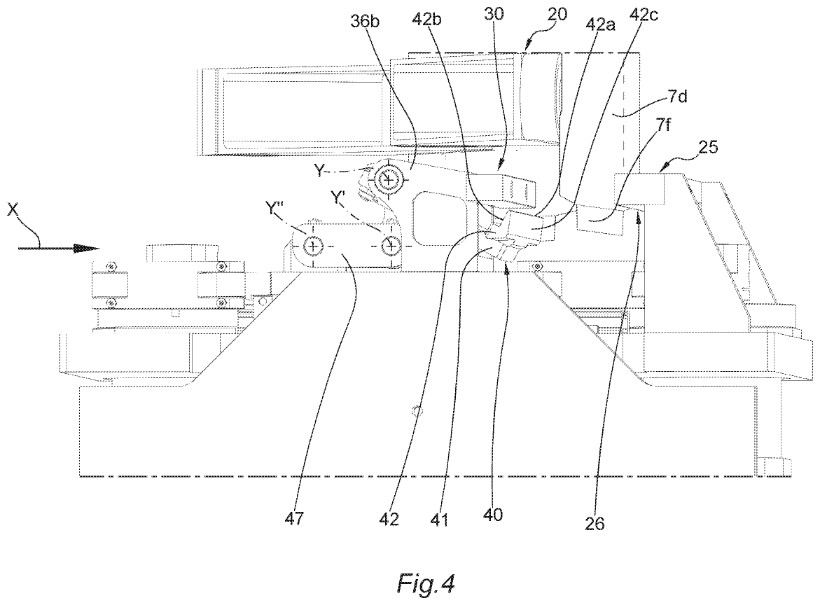

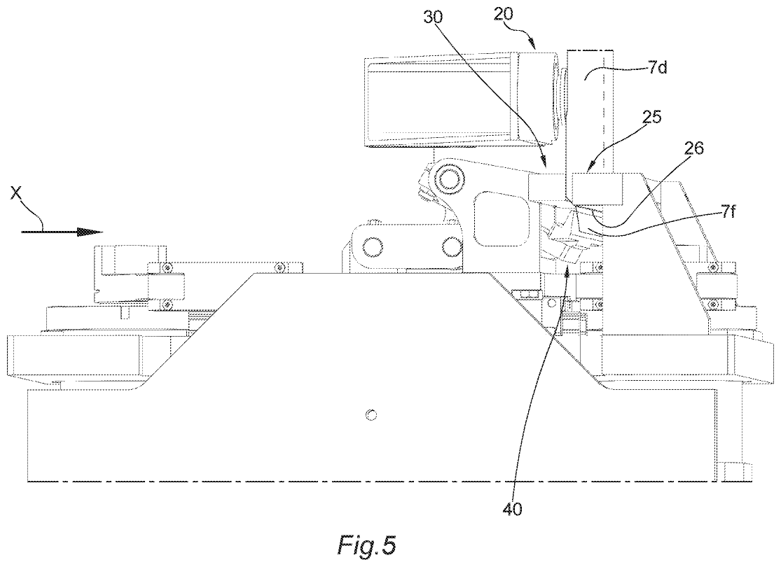

FIGS. 4 and 5 are partial perspective views of the detail of FIG. 3 shown in respective and distinct operating steps,

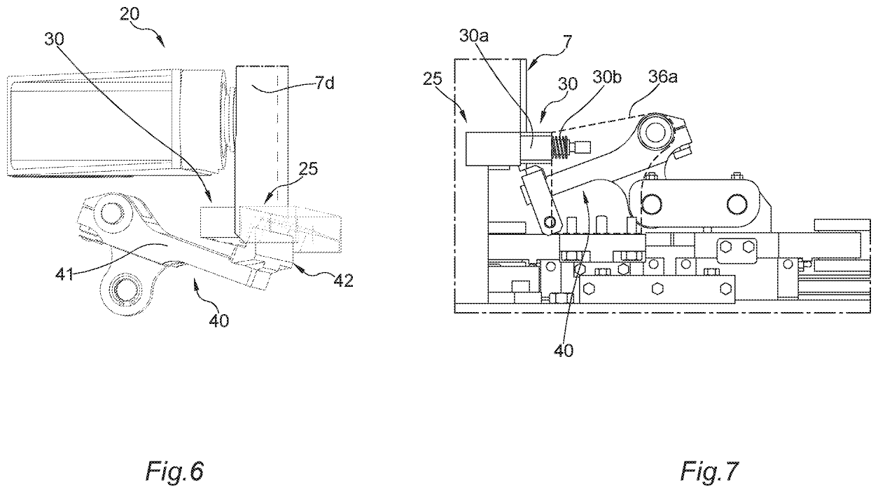

FIG. 6 is a view of a detail of FIGS. 4 and 5 shown in a further, distinct operating step,

FIG. 7 is a further partial perspective view of the detail of FIG. 3,

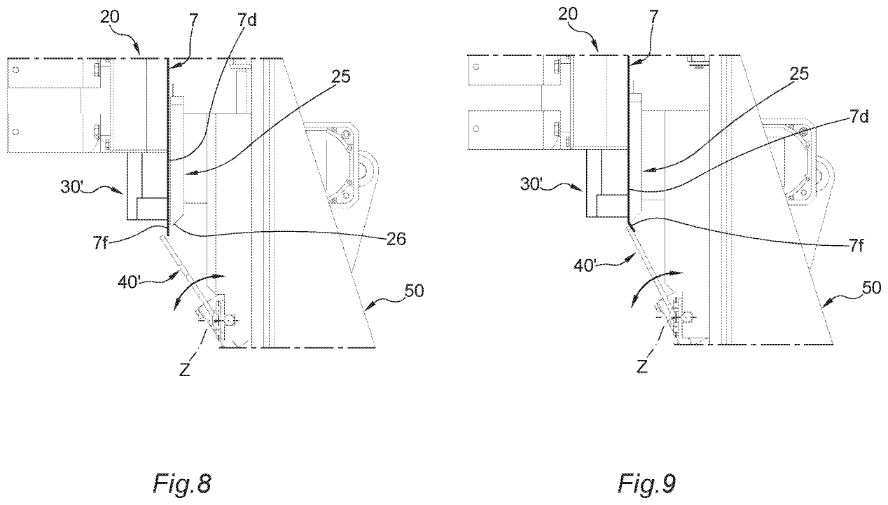

FIGS. 8 and 9 are partial side elevation views of an embodiment of the detail of FIG. 3, shown under respective and distinct operating conditions.

With initial reference to FIG. 1, a packaging unit made in accordance with an embodiment example of the present invention is indicated overall with 100.

The packaging unit 100 is arranged to package one or more articles 1 inside boxes.

The articles 1 are, in this preferred embodiment example, bags containing granular, loose or bulk food products, e.g., cercal flakes.

The packaging unit 100 comprises, in its most general components, an article feeder, a blank feeding device and a folding device 5 of the blanks.

The article feeder can be made in any form adapted to pick up an article 1 from an upstream work station (or from a warehouse) and deliver it to the devices of the packaging unit.

The blank feeding device, in turn, is configured to pick up a single blank 7 from a group of blanks stacked in a stacking zone and bring it in the packaging unit.

The packaging unit 100 is arranged to receive each article 1 from the article feeder and form a respective box around the same, starting from a blank 7 supplied by the blank feeding device.

For this purpose, the packaging unit 100 comprises a mandrel 8 assembled on a carousel, rotatable around a vertical axis, so that the mandrel is moved along a circular trajectory in an advancement direction F. The trajectory is conveniently contained in a horizontal plane.

Thereby, the mandrel 8 is driven along the circular trajectory between a receiving zone, in which the mandrel 8 receives an article 1 from the article feeder, an abutment zone, in which the mandrel 8 abuts a blank 7 supplied by the blank feeding device, a forming zone, in which the blank 7 is folded, being wrapped around the mandrel 8, so as to form a box containing the article 1, an unloading zone, in which the box containing the article 1 is delivered to the subsequent processing stations and, finally, a return zone in which the mandrel 8 is returned to the receiving zone.

The packaging unit 100 comprises a plurality of gripping devices 20 mounted on a carousel system 21 rotatable about a vertical axis, with which the blank feeding device is equipped.

Each gripping device 20 is equipped with gripping members including vacuum-operated suction cups 22 with which each individual blank 7 is grasped and held during handling. Each gripping device 20 is therefore configured to define a gripping position for a corresponding blank 7.

Said blank 7 is made of cardboard and is suitably shaped to form a box when folded around the mandrel 8.

For this purpose, folding lines 7a are obtained in the blank 7 which divide the blank 7 into a plurality of panels intended to form, alone or in combination between them, the different faces of the box.

The folding lines 7a are preferably creases, and each pair of adjacent panels can be swung around a respective folding line 7a separating them.

In particular, in the blank 7 there is identified a central panel 7b as well as two panels 7c, 7d extended from the upper side and from the lower side of the central panel 7b, respectively, and separated therefrom by respective folding lines 7a. From panel 7c a flap 7e is extended, intended for the partial closure of the box in the tubular conformation, which, when the box is formed, is parallel and opposed to the central panel 7b.

For the formation of the opposite bases of the box, from each of the panels 7b, 7c, 7d and from the flap 7e there are extended from opposite sides respective base panels which can swing with respect to the respective side panel at the crease joining them.

The tubular shape assumed by the partially closed box is obtained by joining the flap 7e with an end flap 7f protruding from the panel 7d, which are brought into relative overlap and then joined together, e.g., by gluing.

The flap 7e is also referred to as “outer flap” in that, when overlapped on the end flap 7f, it lies outside the at least partially closed box. Correspondingly, the end flap 7f is also referred to as “inner flap” in that, when overlapped on the flap 7e, it lies between the latter and the inside of the at least partially closed box.

The packaging unit 100 further comprises an abutment element 25 cooperating with each gripping device 20 and configured to at least partially abut the panel 7d of the blank from which the end flap 7f is protruding.

The abutment element 25, e.g. having a plate-shaped conformation, identifies along one of its end profiles a folding edge 26, around which the end flap 7f is folded, as will be described in detail below.

The abutment element 25 is rigidly fixed to a plate 27 of a frame 28 fixed to the ground, and is oriented with respect to the carousel 21 in such a way that the blanks 7, being gripped on the respective gripping devices 20, are made to pass, in sequence to each other, at the abutment element 25, by means of a movement obtained by combining the rotational movement of the carousel 21 with a movement of the corresponding gripping device 20 relative to the carousel 21.

The packaging unit 100 further comprises a pressing element 30 having a main abutment body 30a, e.g. shaped like a bar, which is configured to press the panel 7d against the abutment element 25, in proximity of the folding edge 26.

Said packaging unit 100 further comprises a folding element 40 designed to cooperate with the pressing element 30, said folding element 40 being configured to fold the end flap 7f relative to the panel 7d around the folding edge 26 and in the direction of the abutment element 25. This step of folding the end flap 7f is carried out when the gripping device 20 is in the gripping position for the panel 7d and said panel 7d is pressed by the pressing element 30 against the abutment element 25, according to an operating sequence described in more detail below.

The numerical reference 35 indicates a handling device of the pressing element 30 and 45 indicates a respective and distinct handling device of the folding element 40.

The handling devices 35, 45 comprise respective carriages 36, 46, which are movably guided, by coupling with linear guides fixed to the plate 27, along a common handling trajectory, in this example rectilinear.

The arrow X in the figures indicates the direction of movement of the carriages 36,46 towards the abutment element 25, along the above-mentioned movement trajectory.

Along said trajectory, which is directed perpendicularly to the folding edge 26 of the abutment element 25, the carriages 36, 46 are driven aligned in a row to each other, with the carriage 36 positioned facing the abutment element 25.

In more detail, the pressing element 30 is rigidly attached to the carriage 36 via a pair of opposing supports 36a,36b. Between a main stop body 30a of the pressing element 30 and each support 36a,36b a respective spring 30b is interposed, e.g. in the form of a helical spring.

In FIG. 7, in order to make spring system 30b visible, the supports 36a, 36 have been removed, highlighting only their outline with a dotted line.

It is understood that, as an alternative to the spring system 30b, any means or material with suitable elastic properties may be applied.

The carriage 36 is moved along its handling trajectory by means of a kinematic transmission system interposed between the carriage 36 and a rotary motor 37. Said kinematic system comprises an arm 38 driven in rotation by the motor 37, which is articulated with a connecting rod element 39 which in turn is articulated with the carriage 36, so as to convert the rotational motion of the motor 37 into a translation motion of the carriage 36.

By rotating the motor 37 in one direction or the opposite direction, the carriage 36 is then moved in translation along the rectilinear trajectory in the X direction or in the opposite direction.

A similar kinematic transmission system is provided for the movement of the carriage 46, in which details similar to those of the system referring to the carriage 36 are marked with the same numerical reference to which the graphic sign -′- is added.

In detail, this kinematic system comprises an arm 38′ driven in rotation by a rotary motor 37′. Said arm 38′ is articulated with a connecting rod element 39′ which in turn is articulated with the carriage 46, so as to convert the rotational motion of the motor 37′ into a translational motion of the carriage 46. By rotating the motor 37′ in one direction or the opposite direction, the carriage 46 is then moved in translation along its handling trajectory, in the X direction or in the opposite direction.

The folding element 40 comprises a lever body 41, which is extended at one of its longitudinal ends into a head 42 intended for contact with the end flap 7f of the blank during the folding step.

The head 42 comprises an end portion, tapered in the direction of a free edge 42a and delimited by a pair of abutment surfaces 42b, 42c, which are intended to impact, in sequence to each other, the flap 7f during the folding step.

Axially opposed to the head 42, the lever 41 is articulated with the pressing element 30 via a hinge coupling with a pin 44 mounted between the supports 36a, 36b, so as to rotate about a first axis of rotation Y defined by the pin 44.

The lever 41 is additionally supported articulated on the carriage 46 of the handling device 45. This articulated assembly involves the lever 41 being articulated to a connecting rod 47 around a second axis of rotation Y′, said connecting rod 47 being in turn articulated to the carriage 46 around a respective axis of rotation Y″. The axes of rotation Y, Y′ and Y″ are parallel to each other and spaced apart.

The position and relative distance between the axes of rotation Y and Y′ are chosen in such a way that for a relative movement between the carriages 36 and 46 along their rectilinear handling trajectory, a rotational movement of the folding element 40 with respect to the pressing element 30 is generated. On the other hand, when there is no relative movement between the carriages 36 and 46, i.e. when said carriages are moved synchronously along their handling trajectory, no relative movement is induced between the pressing element 30 and the folding element 40.

The presence or absence of this relative movement is used to perform the end-flap folding step 7f, in the operating sequence described below.

From a remote position of the pressing element 30 and folding element 40 with respect to the abutment element 25, illustrated in FIG. 4, the carriages 36 and 46 are driven, via their respective motion transmission systems, synchronously, in the direction of the abutment element 25, along a first section of their handling trajectory. During this handling step along the first section of the trajectory, the blank 7 is moved by the corresponding gripping device 20 at the abutment element 25 to a stop position in which the blank is stationary with respect to the abutment element, with the panel 7d positioned in abutment thereto.

At the end of the first section of the trajectory, in which the panel 7d is already stopped at the abutment element 25, the carriage 36 is stopped in an operating position, illustrated in FIG. 5, in which the pressing element 30 presses the panel 7d of the blank against the abutment element 25, in proximity of the folding edge 26, i.e. it exerts a pressure action against a region of the panel extending up to a few millimetres from the folding edge 26.

From this position, reached at the end of the first section of the trajectory, only the carriage 46 is moved further, along a second section of the handling trajectory, in the direction of the carriage 36, which is instead maintained in a stopped condition. Along this second section of the handling trajectory, the relative movement between the carriages 36,46 induces the rotational movement of the folding element 40 with respect to the pressing element 30, around the axis of rotation Y. With this rotational movement the folding element 40 is brought to impact the flap 7f folding it, around the folding edge 26, in the direction of the abutment element 25.

In the final position reached at the end of the second section of the trajectory, illustrated in FIG. 6, where for simplification some components of the pressing and folding elements have been omitted, the step of folding the flap 7f is completed, in which the folding element 40 describes the greatest angle of relative rotation, with respect to the pressing element 30, in the direction of the abutment element 25.

The folding angle imposed by the folding element 40 on the flap 7f (measured with respect to the undeformed position of the flap) can preferably take a value comprised between 120° and 130°, but can also reach higher values, up to 150°.

The folding angles imposed by the folding element 40 can in any case ensure, even following a partial elastic release of the fold once the folding action has ceased, that the flap 7f maintains an effective fold for the correct overlap with the outer flap to determine precise gluing thereof when the box is closed.

It should be noted that the first and second sections of the handling trajectory then define a handling stroke towards the abutment element 25 to impact and fold the end flap 7f.

At the end of the second section of the trajectory, a corresponding handling stroke in the opposite direction allows the disengagement of the folding element 40 and the subsequent disengagement of the pressing element 30, until the return to the remote position, away from the abutment element 25, upon reaching which the blank 7 is moved by the gripping device away from the abutment element 25, to allow the arrival of a subsequent blank to be folded.

It should be noted that both the pressing element 30 and the folding element 40 extend along a prevalent part of the end flap dimension 7f extending along the folding edge 26. In this way, it is ensured that the end flap 7f can be effectively yielded along all or a prevalent part of the respective folding line, ensuring on the one hand that the panel 7d is pressed by the pressing element 30 against the abutment element 25 with a substantially uniform pressure in proximity of the folding edge 26 and ensuring on the other hand that the end flap 7f is impacted by the folding element 40 with a pressure distributed substantially uniformly over the entire surface extension of the end flap.

With reference to FIGS. 8 to 9, a second example embodiment of the invention is described below, in which details common to those of the previous example are marked by the same reference numerals, while embodiment variants of details of the previous example are marked by the same reference numerals quoted with the addition of the graphic sign “′”.

In this example, a pressing element 30′ is mounted on the gripping device 20 to move integral with it.

The position of the pressing element 30′ is such that it is substantially “in proximity” of a folding edge 26′ of an abutment element 25′, at a distance of a few millimetres from the edge itself, in a manner entirely analogous to the example described above.

A folding element 40′ is mounted on a frame 50 fixed to the gripping device and to which the abutment element 25′ is additionally fixed.

The folding element 40′ is provided in the form of a plate articulated to the frame 50 to rotate about an axis of rotation Z and bearing an end profile configured to impact the end flap 7f of the blank, folding the flap 7f around the folding edge 26′ in the direction of the abutment element 25′, when the panel 7d is pressed by the pressing element 30′ against the abutment element 25′.

In a further implementation variant of this second example, it can be envisaged that the pressing element 30′ is mounted on the gripping device 20′ in a movable manner with respect to the gripping device itself.

In a further implementation variant, it can be envisaged that the pressing element 30′ is not mounted on the gripping device 20, but is instead moved independently of both the gripping device and the folding element, providing for the appropriate phasing of the relative movements between said elements, in order to ensure the correct sequence of the operating steps suitable for folding the end flap.

1.-19. (canceled)

20. A packaging unit for packaging articles into boxes, comprising:
a gripping device for gripping at least one blank to be folded to form a box configured to contain at least one of said articles, said at least one blank having at least one panel and at least one end flap extended from said at least one panel, said gripping device being configured to define a gripping position for said at least one panel,
an abutment element configured to abut at least partially said at least one panel and bearing a folding edge,
a pressing element configured to press said at least one panel against said abutment element in proximity of said folding edge, and
a folding element configured to fold said at least one end flap relative to said at least one panel about said folding edge and in a direction of said abutment element when said gripping device is in the gripping position for said at least one panel and said at least one panel is pressed at least partially by said pressing element against said abutment element.

21. The packaging unit according to claim 20, wherein said pressing element is movable with respect to the gripping device.

22. The packaging unit according to claim 20, comprising respective and separate handling devices for handling said pressing element and said folding element.

23. The packaging unit according to claim 22, wherein the handling device for the pressing element and the handling device for the folding element are movably guided along a common handling trajectory.

24. The packaging unit according to claim 23, wherein said common handling trajectory is rectilinear.

25. The packaging unit according to claim 20, wherein said folding element is articulated to said pressing element to rotate about a first axis of rotation.

26. The packaging unit according to claim 22, wherein said pressing element is rigidly fixed on its respective handling device and the folding element is supported in an articulated manner on its respective handling device about a second axis of rotation.

27. The packaging unit according to claim 26, wherein said folding element is articulated to said pressing element to rotate about a first axis of rotation and wherein the first and second axes of rotation are parallel and spaced apart from one another.

28. The packaging unit according to claim 26, wherein said folding element is articulated to said pressing element to rotate about a first axis of rotation and wherein said first and second axes of rotation are directed transverse to the common handling trajectory.

29. The packaging unit according to claim 22, wherein said handling devices are configured to be driven synchronously along at least a first section of the common handling trajectory, so that the pressing element and the folding element are driven without any relative movement between each other.

30. The packaging unit according to claim 29, wherein the handling device of the folding element is configured to be driven, along a second section of the common handling trajectory, in a relative movement with respect to the handling device of the pressing element, so that the folding element is moved in a relative rotation movement with respect to the pressing element.

31. The packaging unit according to claim 30, wherein said first and second sections follow one another defining a handling stroke towards said abutment element, at the end of the first section the pressing element being moved to an operating position wherein the pressing element presses said at least one panel of the blank against the abutment element and in the second section the folding element being moved to fold the at least one end flap about the folding edge while the pressing element is maintained in said operating position.

32. The packaging unit according to claim 22, wherein the handling device of the pressing element and the handling device of the folding element are movably guided on a frame structurally independent from said gripping device.

33. The packaging unit according to claim 20, wherein said pressing element is mounted on the gripping device that is configured to grip said at least one blank.

34. The packaging unit according to claim 20, wherein the pressing element and the folding element are configured to respectively press the at least one panel of the blank against the abutment element and fold the end flap, when the blank is stopped in a stop position at the abutment element.

35. The packaging unit according to claim 20, comprising a plurality of said gripping devices mounted on a rotatable carousel, which are configured in such a way that in a rotary movement of said carousel, the plurality of gripping devices are driven, in succession to each other, towards said abutment element to fold the end flap of the blank gripped on the corresponding gripping device.

36. A method for packaging articles into boxes comprising:
arranging a blank to be folded to form a box configured to contain at least one of said articles, said blank having at least one panel and at least one end flap extended from said at least one panel,
abutting the at least one panel by an abutment element bearing a folding edge,
pressing the at least one panel against said abutment element in proximity of said folding edge, and
folding said at least one end flap relative to said at least one panel about the folding edge and in the direction of said abutment element, when said at least one panel is pressed against said abutment element.

37. The packaging method according to claim 36, comprising:
arranging a pressing element to press the at least one panel,
arranging a folding element to fold the end flap, and
moving said pressing element and said folding element to and from said abutment element along a common trajectory.

38. The packaging method according to claim 36, comprising:
grasping the at least one blank by a gripping device, and
moving the gripping device to move the at least one gripped blank to and from said abutment element.
